(19) United States
(12) Patent Application Publication
(10) Pub. No.: US 2016/0017833 A1
(43) Pub. Date: Jan. 21, 2016

(54) Method and device for operating an internal combustion engine

(71) Applicant: Robert Bosch GmbH, Stuttgart (DE)

(72) Inventors: Alexander Carsten ULRICH, Tamm (DE); Stefan Gottlieb, Hemmingen (DE)

(21) Appl. No.: 14/799,303

(22) Filed: Jul. 14, 2015

(30) Foreign Application Priority Data
Jul. 16, 2014 (DE) 10 2014 213 825.6

(51) Int. Cl. F02D 41/26; F02D 41/06; F02D 41/00

(52) U.S. Cl. CPC F02D 41/26; F02D 41/008; F02D 41/064; F02D 41/0002

(57) ABSTRACT

A method for operating an internal combustion engine in a cold start operation includes: operation of at least one first cylinder and at least one second cylinder of the internal combustion engine using air-fuel mixtures having different air-fuel ratios to introduce unburned fuel and fresh air into an exhaust tract section, so that an exothermic secondary reaction takes place in an exhaust aftertreatment component; and individual adjustment of an amount of fresh air supplied for each of the at least one first and at least one second cylinders to adjust their torque contributions to one another.

### BACKGROUND OF THE INVENTION

1. Field of the Invention

The present invention relates to internal combustion engines, in particular measures for operating internal combustion engines to effectuate an exothermic secondary reaction of the fuel in the exhaust tract section.

2. Description of the Related Art

After a cold start of an internal combustion engine, an exhaust aftertreatment component for reducing emissions, such as a catalytic converter, for example, situated in the exhaust tract section should usually be heated as rapidly as possible to a working temperature by a cold start operation of the internal combustion engine to thereby promptly achieve the function of reducing emissions. A conventional procedure for this is to transport atmospheric oxygen and unburned fuel through the cylinders into the exhaust tract section by various operating methods, so that an exothermic secondary reaction of the fuel may take place there. The heat thereby generated heats the exhaust aftertreatment component more rapidly.

The published German patent application document DE 101 31 802 A1 describes a method in which cylinders of an internal combustion engine may be operated in different modes of operation. For example, one set of cylinders may be operated using an air-fuel mixture, which is too rich, and another set of cylinders may be operated using an air-fuel mixture, which is too lean, so that unburned fuel, on the one hand, and unburned fresh air, on the other hand, enters the exhaust tract section and is made available there by an exothermic secondary reaction for heating a catalytic converter.

Since the air-fuel ratio of an air-fuel mixture, which is too rich or too lean, effectuates a lower torque, there is an adjustment of the partial torques supplied by the cylinders during the cold start operation via an adjustment of the cylinder charge. It is therefore possible to provide, for example, that the setpoint torque is adjusted by increasing the setpoint charge on the average, and both sets of cylinders are operated at a rich or lean air-fuel ratio. The torque contributions (partial torques) of the individual cylinders are of different sizes due to the different lambda efficiency, i.e., the efficiency resulting with respect to the air-fuel ratio, resulting in rough engine operation.

In addition, it may be provided that the setpoint torque is to be adjusted via a retarded ignition angle setting, so that the torque contributions of the individual cylinders may be adjusted to one another. However, the mechanical efficiency of the cylinders operated at the better lambda efficiency is lower due to the retarded ignition angle setting, and an exhaust aftertreatment component downstream from only these cylinders is exposed to a higher thermal load.

### BRIEF SUMMARY OF THE INVENTION

According to one first aspect of the present invention, a method for operating an air-guided internal combustion engine in a cold start operation is provided, including the following steps:
operating at least one first cylinder and at least one second cylinder of the internal combustion engine using air-fuel mixtures having different air-fuel ratios, to introduce unburned fuel and fresh air into an exhaust tract section, which is provided for discharging exhaust gas from combustion, so that there is an exothermic secondary reaction in an exhaust aftertreatment component; and
individual adjustment of a supplied amount of fresh air for each of the at least one first and at least one second cylinder, to adjust their torque contributions to one another.

In addition, the first cylinder may be operated using a rich air-fuel mixture, and the second cylinder may be operated using a lean air-fuel mixture.

One idea of the above-mentioned method for operating the internal combustion engine relates to internal combustion engines in which the air charge may be adjusted individually for each cylinder but at least individually for the individual cylinder groups.

The above-mentioned method relates to a cold start operation, in which an exhaust aftertreatment component is to be heated to an operating temperature in an exhaust tract section of an internal combustion engine. Cylinders of the internal combustion engine should therefore be operated in such a way that unburned fuel and unburned fresh air enter the exhaust tract section to generate heat there in an exothermic secondary reaction, which heats up the exhaust aftertreatment component.

To achieve the amounts of unburned fuel and air in the exhaust tract section, one or multiple first cylinders are operated using an air-fuel mixture having a rich air-fuel ratio, i.e., having an air-fuel ratio lower than the air-fuel ratio at a stoichiometric equilibrium (lambda value <1), and one or multiple second cylinders using an air-fuel mixture having a lean air-fuel ratio, i.e., having an air-fuel ratio higher than the air-fuel ratio in a stoichiometric equilibrium (lambda value >1).

At different air-fuel ratios, different efficiencies, i.e., different torque contributions (partial torques), are supplied by the cylinders without further measures, which may result in rough running of the internal combustion engine under some circumstances. To prevent rough running due to unequal torque contributions of at least one first and at least one second cylinder, the air charges of the cylinders are adjusted individually, in such a way that torque contributions or partial torques are supplied during operation using a rich air-fuel ratio or a lean air-fuel ratio, their differences being reduced with respect to the operating case without individual cylinder adjustment. It is therefore possible to avoid any rough running.

Due to individual adjustments of the cylinder charges, so that the partial torques or torque contributions supplied by the corresponding first and second cylinders approach one another or are equal, the unburned fuel and fresh air in the exhaust tract section needed for cold start operation are supplied on the one hand, and, on the other hand, this prevents rough running, which would result from the different torque contributions of the cylinders of the cylinder groups.

On the whole, very smooth running is achievable with a high mechanical efficiency at the same time, due to the above-mentioned method for operating an internal combustion engine.

In particular, the amount of fresh air supplied for the first cylinder may be reduced and/or the amount of fresh air supplied for the second cylinder may be increased.

According to one specific embodiment, the amounts of fresh air supplied for each of the at least one first and at least one second cylinder may be adjusted individually so that the torque contributions of each of the at least one first and at least one second cylinders are equal.

At least one third cylinder, which is operated using an optimal air-fuel mixture with respect to efficiency, may be provided, the amounts of fresh air supplied being adjusted individually for each of the at least one first and at least one second cylinders, so that the torque contributions of each one of the at least one first and at least one second cylinders correspond to the torque contribution of the at least one third cylinder.

It may be provided that an ignition timing of the at least one first cylinder is set to support the adjustment of the torque contributions.

According to another aspect, a device, in particular a control unit, for operating an air-guided internal combustion engine in a cold start operation is provided, the device being designed:
to operate at least one first cylinder and at least one second cylinder of the internal combustion engine using air-fuel mixtures having different air-fuel ratios, to introduce unburned fuel and fresh air into an exhaust tract section, so that an exothermic secondary reaction takes place in an exhaust aftertreatment component;
to set supplied amounts of fresh air individually for each cylinder, so that torque contributions of the cylinders are adjusted to one another.

According to another aspect, an engine system including an internal combustion engine and the above device is provided.

According to additional aspects, a computer program for executing the above method, a machine-readable memory medium, on which the computer program is stored, and a control unit which includes the machine-readable memory medium are provided.

### BRIEF DESCRIPTION OF THE DRAWINGS

FIG. 1 shows a schematic representation of an engine system which includes an internal combustion engine.

FIGS. 2a and 2b show a diagram for representing the lambda efficiency and the torque contribution of one cylinder.

FIG. 3 shows a function diagram for schematic representation of how the setpoint charge for the cylinders of each cylinder group of the internal combustion engine is ascertained.

FIG. 4 shows a diagram for representing the torque contributions of one cylinder of each of the various cylinder groups.

### DETAILED DESCRIPTION OF THE INVENTION

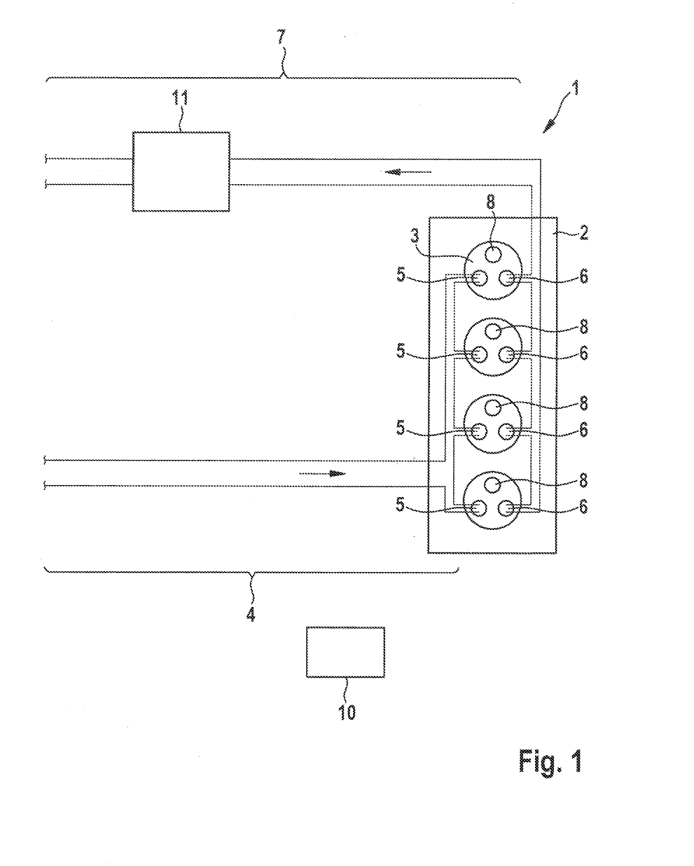

FIG. 1 shows a schematic representation of an engine system 1 which includes an internal combustion engine 2. Internal combustion engine 2 is designed as an air-guided internal combustion engine, in particular as a gasoline engine.

Internal combustion engine 2 has multiple cylinders 3, usually four, each being supplied with air via an air supply section 4. Air supply section 4 is divided among each cylinder 3, an intake valve 5 being provided for each cylinder 3 to control the amount of air introduced into the cylinders on an individual cylinder basis.

Intake valves 5 are coupled to a camshaft (not shown) and may be provided as essentially known electrohydraulic valves, for example, which provide or suppress coupling to the camshaft. An opening point in time of each intake valve may be controlled separately through the choice of a suitable coupling point in time with the camshaft, and in particular may be delayed in comparison with the camshaft movement. The amount of fresh air drawn into corresponding cylinder 3 is controllable through the choice of the opening point in time.

In addition, exhaust valves 6, which exhaust the combustion exhaust out of cylinders 3 into an exhaust tract section 7, are provided.

Injectors 8, whose opening durations determine the amount of fuel injected, and which are individually triggerable for each cylinder 3, are provided for supplying fuel to each individual cylinder.

For the operation of internal combustion engine 2, a control unit 10 is provided, which controls intake valves 5 and the injection of fuel through injectors 8 to operate internal combustion engine 2.

An exhaust aftertreatment component 11, such as a catalytic converter or the like, for example, for reducing emissions is provided in exhaust tract section 7.

During a cold start of engine system 1, exhaust aftertreatment component 11 is at an ambient temperature or a temperature lower than an operating temperature at which treatment of the combustion exhaust is optimal. After the cold start, there is thus little or no aftertreatment of the combustion exhaust gas from internal combustion engine 2, i.e., the treatment is not optimal. It is provided in general that measures are taken to bring exhaust aftertreatment component 11 to its operating temperature of a few hundred degrees C. as rapidly as possible to reduce polluting emissions. This takes place in the operating mode known as cold start operation. In the case of a catalytic converter as an exhaust aftertreatment component, this is also referred to as CAT heating operation.

A method described at the outset is known as the lambda split method and provides that a first cylinder group is operated using a first set of cylinders 3 using an air-fuel mixture, whose air-fuel ratio is lower than the air-fuel ratio at a stoichiometric equilibrium (lambda value <1). However, a second set of cylinders 3 of a second cylinder group is operated using an air-fuel mixture whose air-fuel ratio is higher than the air-fuel ratio at a stoichiometric equilibrium (lambda value >1). It is also said that cylinder 3 of the first cylinder group is operated using a rich mixture and that cylinder 3 of the second cylinder group is operated using a lean mixture. A lambda value of 1 denotes an air-fuel ratio at a stoichiometric equilibrium; a lambda value of <1 denotes an air-fuel mixture at which more fuel is present in comparison with the stoichiometric equilibrium; and a lambda value of >1 denotes an air-fuel mixture with an air excess. Unburned fuel and fresh air therefore enter exhaust tract section 7, react exothermically with one another there and heat exhaust aftertreatment component 11 through the resulting heat.

During a cold start operation, the total torque supplied by internal combustion engine 2 is preferably retained or corresponds to a required torque. In particular the torque contribution or the partial torque of each cylinder 3 should preferably be equal or approach one another.

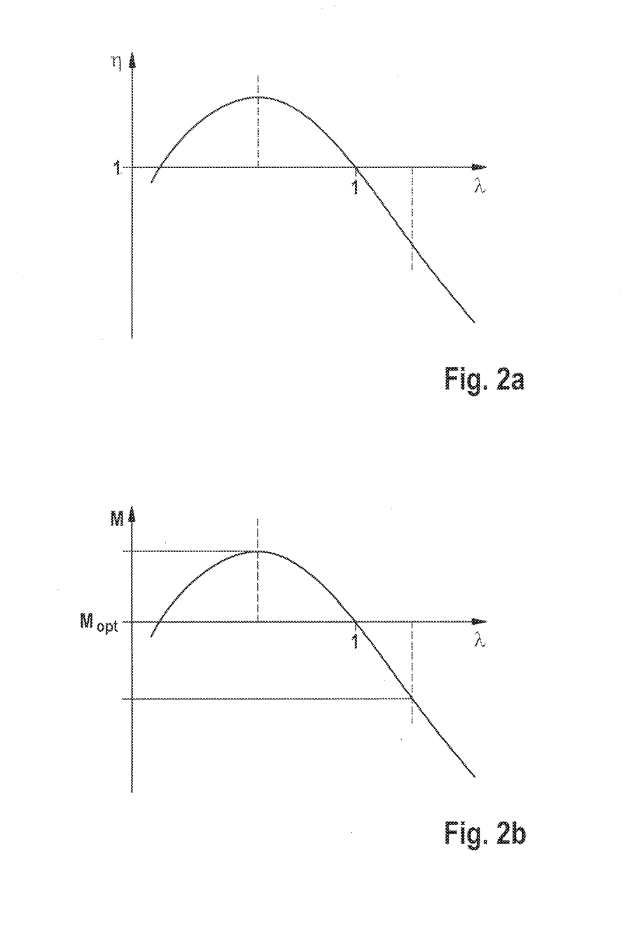

A curve is obtained for the air-fuel ratio, given as lambda value λ, as shown in the diagram in FIG. 2a, for lambda efficiency η, which indicates a relation of the supplied torque as a function of the air charge. Accordingly, as represented in the diagram in FIG. 2b, the curve of torque M supplied by a cylinder 3 of the internal combustion engine results at a certain air charge rl as a function of lambda value λ.

It is apparent that, during rich operation of internal combustion engine 2, starting from a stoichiometric equilibrium, the mechanical power with respect to a lambda value 1 initially increases beyond an optimal engine torque Mₒₚₜ before decreasing again. However, the mechanical power, i.e., the supplied torque, declines continuously with increasing lambda values, starting from the stoichiometric equilibrium.

It may now be provided that, initially, each cylinder 3 should supply an equal torque contribution and at the same time be operated using the corresponding lambda value (individual for each cylinder), i.e., with the corresponding air-fuel ratio.

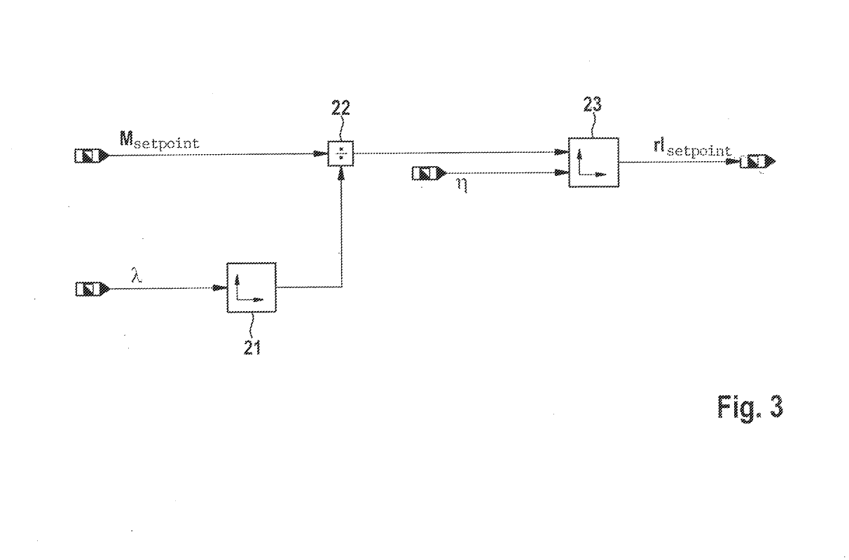

FIG. 3 shows a function diagram, according to which a setpoint charge rlₛₑₜₚₒᵢₙₜ is obtained for each cylinder 3 from a supplied torque contribution Mₛₑₜₚₒᵢₙₜ and a supplied air-fuel ratio, given as lambda value λ. Lambda value λ is predefined for each cylinder 3 as a function of the operating mode. Lambda values λ greater than and less than 1 are thus provided for the first and second cylinder groups to obtain an exothermic secondary reaction in exhaust tract section 7.

Based on lambda value λ, which is predefined for each individual cylinder, a lambda efficiency η is ascertained with the aid of a predefined lambda efficiency engine characteristics map 21. The torque contribution to be supplied is divided by the resulting lambda efficiency η in a division block 22, and the result is transmitted to a charge characteristics map 23 made available. A setpoint charge rlₛₑₜₚₒᵢₙₜ for corresponding cylinder 3 may be ascertained at the instantaneous rotational speed and other states of the instantaneous operation of internal combustion engine 2 from the torque contribution corrected by lambda efficiency η in charge characteristics map 23. Thus, with stipulation of a desired lambda value for each cylinder 3, a certain setpoint charge rlₛₑₜₚₒᵢₙₜ may be predefined for each individual cylinder. Through appropriate setting of intake valve 5 assigned to cylinder 3, the charge may be set accordingly in cylinders 3.

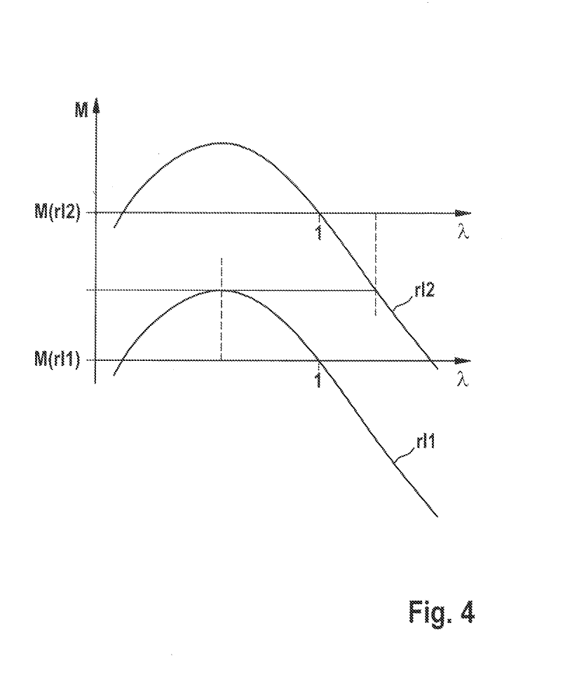

FIG. 4 shows the torque contributions of a cylinder 3 operated using a rich mixture and using a lean mixture in the form of a diagram (cylinders of the first and second cylinder groups, respectively). In particular the cylinder operated using a rich mixture is preferably operated at a lambda value λₘₐₓ, i.e., at an air-fuel ratio at which a maximum lambda efficiency η is achieved. By individual adjustment of setpoint charges rl1, rl2 for cylinder 3 operated using a rich mixture and using a lean mixture, torques M(rl1), M(rl2) supplied by two cylinders 3 are adjusted to one another, so that internal combustion engine 2 is operated using torque contributions, which are equal for all cylinders 3.

In addition to the adjustment of the cylinder charges, a retard of an ignition angle may also be provided for reducing the torque contribution of cylinder 3 operated using a lean mixture and using a rich mixture. In these cases, the amount of fresh air supplied into exhaust tract section 7 and the amount of unburned fuel supplied into exhaust tract section 7 may be further increased, so that even faster heating of exhaust aftertreatment component 11 is achievable.

What is claimed is:

1. A method for operating an internal combustion engine in a cold start operation, comprising:
operating at least one first cylinder and at least one second cylinder of the internal combustion engine using air-fuel mixtures having different air-fuel ratios to introduce unburned fuel and fresh air into an exhaust tract section, whereby an exothermic secondary reaction takes place in an exhaust aftertreatment component; and
performing individual adjustments of amount of fresh air supplied for each of the at least one first cylinder and the at least one second cylinder to adjust respective torque contributions of the cylinders.

2. The method as recited in claim 1, wherein the at least one first cylinder is operated using a rich air-fuel mixture and the at least one second cylinder is operated using a lean air-fuel mixture.

3. The method as recited in claim 2, wherein at least one of (i) the amount of fresh air supplied for the at least one first cylinder is reduced, and (ii) the amount of fresh air supplied for the at least one second cylinder is increased.

4. The method as recited in claim 3, wherein the amounts of fresh air supplied are adjusted individually for each of the at least one first cylinder and the at least one second cylinder, so that the torque contributions of each one of the at least one first cylinder and the at least one second cylinder are equal.

5. The method as recited in claim 2, wherein at least one third cylinder is operated using an air-fuel mixture which is optimal with respect to efficiency, the amounts of fresh air supplied being adjusted individually for each of the at least one first cylinder and the at least one second cylinder, so that the torque contributions of each of the at least one first cylinder and the at least one second cylinder correspond to the torque contribution of the at least one third cylinder.

6. The method as recited in claim 5, wherein an ignition timing of the at least one first cylinder is controlled to aid the adjustment of the respective torque contributions of the at least one first and second cylinders.

7. A control unit for operating an internal combustion engine during a cold start operation, comprising:
a controller including a processor configured to control the following:
operating at least one first cylinder and at least one second cylinder of the internal combustion engine using air-fuel mixtures having different air-fuel ratios to introduce unburned fuel and fresh air into an exhaust tract section, whereby an exothermic secondary reaction takes place in an exhaust aftertreatment component; and
performing individual adjustments of amount of fresh air supplied for each of the at least one first cylinder and the at least one second cylinder to adjust respective torque contributions of the cylinders.

8. The control unit as recited in claim 7, wherein the control unit is part of an engine system which also includes the internal combustion engine.

9. The control unit as recited in claim 8, wherein the engine system includes an exhaust aftertreatment component which is heatable in the cold start operation by supplying unburned fuel and fresh air, the exhaust aftertreatment component being situated in an exhaust tract section.

10. A non-transitory computer-readable data-storage medium storing a computer program having program codes which, when executed on a computer, perform a method for operating an internal combustion engine in a cold start operation, the method comprising:
operating at least one first cylinder and at least one second cylinder of the internal combustion engine using air-fuel mixtures having different air-fuel ratios to introduce unburned fuel and fresh air into an exhaust tract section, whereby an exothermic secondary reaction takes place in an exhaust aftertreatment component; and
performing individual adjustments of amount of fresh air supplied for each of the at least one first cylinder and the at least one second cylinder to adjust respective torque contributions of the cylinders.
